(19) United States
(12) Patent Application Publication
(10) Pub. No.: US 2015/0348126 A1
(43) Pub. Date: Dec. 3, 2015

(54) PERSONALIZED USER ENGAGEMENT SYSTEM USING OPERATING SYSTEM NOTIFICATION SCRIPT

(71) Applicant: Transilio, Inc., Boise, ID (US)

(72) Inventors: Evans BAIYA, Meridian, ID (US); Eric EILERTSEN, Scottsdale, AZ (US); Carol Lloyd MAHAFFEY, Eagle, ID (US)

(73) Assignee: Transilio, Inc., Boise, ID (US)

(21) Appl. No.: 14/725,721

(22) Filed: May 29, 2015

Related U.S. Application Data
(60) Provisional application No. 62/005,666, filed on May 30, 2014.

(51) Int. Cl. G06Q 30/02; G06Q 10/10; H04L 12/58

(52) U.S. Cl. CPC G06Q 30/0269; G06Q 30/0264; H04L 51/08; G06Q 10/107

(57) ABSTRACT

Systems and methods for user engagement are provided. The methods may include retrieving user information of a user from a local registry on a user computing device; delivering a notification of personalized content to the user using an interface of the user computing device, wherein the notification is generated based at least on the user information retrieved from the local registry; and delivering the personalized content to the user based on an interaction of the user with the notification. The systems may include a user computing device including a user interface configured to interact with a user, a storage device configured to store thereon a local registry, and a user engagement software module configured to retrieve user information of a from the local registry; and a content server configured to store a personalized content.

### CROSS REFERENCE TO RELATED APPLICATION

This application claims priority from Provisional U.S. Application No. 62/005,666, filed May 30, 2014, which is incorporated herein by reference in its entirety as if fully sent forth herein.

### BACKGROUND

For years, businesses have been struggling with how to engage their customers after they have made their purchases (physically or virtually) at a commerce location. This is particularly relevant in medical services and the retail environment. The lack of post-purchase engagement often has resulted in non-adherence in the case of medications, returned merchandise in the case of physical goods, lack of loyalty in the case of services, and lost business opportunities associated with the lack of ongoing linkages. Post-purchase engagement would yield significant benefits to both service providers and the consumers themselves.

A specific case study involves consumer adherence to pharmaceutical medication. Nearly 50% of U.S. citizens take prescriptions, and nearly 3.7 billion prescriptions are written each year. Over 75% of Americans self-report that they do not take their medications as directed, and 33% never fill their prescriptions at all. This non-adherence has been costly through premature deaths, long-term sicknesses, and economic losses. Studies have suggested a lack of education (e.g., not understanding one's medical condition, the efficacy or side effects of a drug) and forgetfulness account for nearly 70% of the non-adherence problem. To address the non-adherence issue, the medics would like to spend more time educating their patients. It is also well documented that the “human-process bottleneck” in medicine is a reality; doctors do not have as much time as desired with patients, only a fraction of patients receive counseling from pharmacists and the patient “take-away” from their pharmacy visit consists of tiny print on a difficult to read drug-fact sheet.

Another case study involves the consumer adoption of home electronics. Millions of home-electronics are purchased worldwide, including personal computers. Many people struggle to learn how to use them, resulting in low utilization, incorrect utilization, fatalities and a high rate of returns back to the stores. The returns are expensive to the retailers. Retailers therefore acknowledge that post-purchase engagement with the consumer is important to the adoption of the technology, customer loyalty and overall economics. However, retailers have experienced a significant disconnect between the purchaser, the manufacturer, and the retailers themselves as most purchasers never provide explicit feedback on how they utilize the electronics they have purchased.

Computing device manufacturers and retailers use emails, blog sites, social media sites, websites with various types of content, and RSS feeds and mobile applications to educate their customers on how best to use the devices, promote associated services and accessories, and create a positive brand experiences.

However, these methods often need the customer user to go to a particular destination, email client, website, or a mobile application to find out about some notification, which would request the user to open the emails and then to be redirected to a website that filters through various types of content to hopefully to identify the relevant content. The content is often not personalized, intuitive, irrelevant, and poorly designed, and thus provides low incentive for the customer user to open and follow through on the notification. This often results in very low open rates of emails and low utilization of mobile applications especially for e-commerce and enterprise applications.

### SUMMARY

In view of the foregoing, the Inventors have recognized and appreciated the advantages of a personalized user engagement system using operating system notification script.

Accordingly, provided in one embodiment is a method. The method includes retrieving user information of a user from a local registry on a user computing device. The method further includes delivering a notification of personalized content to the user using an interface of the user computing device, wherein the notification is generated based at least on the user information retrieved from the local registry. The method further includes delivering the personalized content to the user based on an interaction of the user with the notification.

In some embodiments, the method is provided so that the notification comprises a passive notification popup.

In some embodiments, the method is provided so that the notification comprises a GROWL style notification.

In some embodiments, the method is provided so that the notification comprises a passive notification popup, and the interaction of the user with the notification comprises the user interacting with the passive notification popup.

In some embodiments, the method is provided so that the notification comprises a passive notification popup, the interaction of the user with the notification comprises the user interacting with the passive notification popup, and the delivering the content to the user further comprises loading a webpage identified by a uniform resource identifier associated with the passive notification popup.

In some embodiments, the method is provided so that the notification comprises a passive notification popup, the interaction of the user with the notification comprises the user interacting with the passive notification popup, and the delivering the personalized content to the user further comprises launching a native content application installed on the user computing device.

In some embodiments, the method is provided so that the notification comprises a passive notification popup, the interaction of the user with the notification comprises the user interacting with the passive notification popup, and the passive notification popup is personalized for the user based at least on the user information retrieved from the local registry.

In some embodiments, the method further includes interfacing with a content management system, that the content management system is installed on a remote computing device, and wherein the interfacing with a content management system further comprises communication between a user engagement software module installed on the user computing device and the content management system over a data communications network.

In some embodiments, the method further includes interfacing with a content management system, that the content management system is installed on a remote computing device, that the interfacing with a content management system further comprises communication between a user engagement software module installed on the user computing device and the content management system over a data communications network, and that the content is determined at least by the content management system.

In some embodiments, the method further includes generating a schedule for content delivery based at least on the user information retrieved from the local registry.

In some embodiments, the method further includes generating a schedule for content delivery based at least on the user information retrieved from the local registry, and that the delivering a notification of personalized content to the user is performed based on the schedule for content delivery.

In some embodiments, the method is provided so that the user information of the user is stored in the local registry as a part of a registration process for the user and the user computing device.

In some embodiments, the method is provided so that the delivering the personalized content to the user is based at least on rules for content delivery.

In some embodiments, the method is provided so that the delivering the personalized content to the user is based at least on rules for content delivery, that the rules for content delivery are stored by a user engagement software module installed on the user computing device, and that the rules for content delivery include at least one of: rules specifying an interface for delivery of content notifications, rules specifying a mode for delivery of content notifications, and rules specifying a frequency of delivery of content notifications.

In some embodiments, the method further includes installing a user engagement software module on the user computing device, and that the user engagement software module is configured to perform the retrieving the user information of the user from the local registry.

According to another embodiment, a system is provided. The system includes a user computing device that includes a user interface configured to interact with a user, a storage device configured to store thereon a local registry, and a user engagement software module configured to retrieve user information of a user from the local registry. The system further includes a content server configured to store a personalized content. The system is provided so that the user engagement software module is configured to deliver a notification of the personalized content to the user on the user interface, the user engagement software module is configured to generate the notification based at least on the user information retrieved from the local registry, and the content server is configured to deliver the personalized content to the user computing device based at least on an interaction of the user with the notification.

In some embodiments, the system is provided so that the user engagement software module is further configured to generate a schedule for content delivery based at least on the user information retrieved from the local registry.

In some embodiments, the system is provided so that the user engagement software module is installed on the user computing device prior to a sale of the user computing device to the user, and the sale of the user computing device to the user is a first retail sale of the user computing device.

In some embodiments, the system is provided so that the user engagement software module is installed on the user computing device as part of an installation of an update to an operating system executing on the user computing device.

According to another embodiment, a non-transitory machine-readable computer medium stored thereon a program is provided. The program is provided so that, when executed, the program causes a user computing device to perform the method including retrieving user information of a user from a local registry on a user computing device, delivering a notification of personalized content to the user using an interface of the user computing device, wherein the notification is generated based at least on the user information retrieved from the local registry, and delivering the personalized content to the user based on an interaction of the user with the notification.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a system diagram showing a system for user engagement according to some embodiments.

FIG. 2 is a component diagram showing a user engagement script according to some embodiments.

FIG. 3 is a schematic flowchart showing a user engagement technique according to some embodiments.

FIG. 4 is an exemplary registration interface according to some embodiments.

FIG. 5 is an exemplary user computing device interface with a content notification according to some embodiments.

FIG. 6 is an exemplary content interface with personalized content according to some embodiments.

FIG. 7 is a flowchart showing a process of user engagement according to some embodiments.

FIG. 8 is a flowchart showing a process of user engagement according to some embodiments.

### DETAILED DESCRIPTION

Following below are more detailed descriptions of various concepts related to, and embodiments of, inventive techniques for delivery of personalized content and notifications thereof to users. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

In the following disclosure, some terms may be used with special meaning to the present embodiments. The term “consumer” or “customer” is used. In some embodiments, a “consumer” or a “customer” is an all-inclusive definition of a person who receives a service, purchases a product, attends a course, and/or is involved in a commercial activity as a receiver of that commerce. The term “pathway” is used. In some embodiments, a “pathway” is a personalized engagement roadmap that is created algorithmically for a consumer to further enhance his/her knowledge about the product or service he/she has received. The term “purchasing data” is used. In some embodiments, “purchasing data” refers to the data involving the consumer's actions at the point of service provision or purchase. The term “promotional” is used with various other terms, such as “promotional video,” “promotional offer,” “promotional information,” etc. In some embodiments, “promotional” means something generally tending to promote the purchase, consumption, or other use of some product, service, or other item. The terms “computer,” “computing device,” and other similar variations are used. In some embodiments, these terms refer similarly to electronic computing devices. These may be implemented in various forms, including cellular telephones, smart phones, PDAs, tablet computers, laptop computers, desktop computers, and other forms of a device that comprises a processor. The terms “point of engagement” and “point of interaction” are used. In some embodiments, these phrases refer similarly to a point wherein a consumer has some sort of interaction, engagement, transaction, etc. These phrases may refer to a point of sale in some embodiments. The terms “interactions” and “engagements” and other similar terms are used. In some embodiments, these terms are used similarly to refer to contact made by the system with a user in order to interact with the user and thereby engage the user. Other similar terms may be used to describe this action.

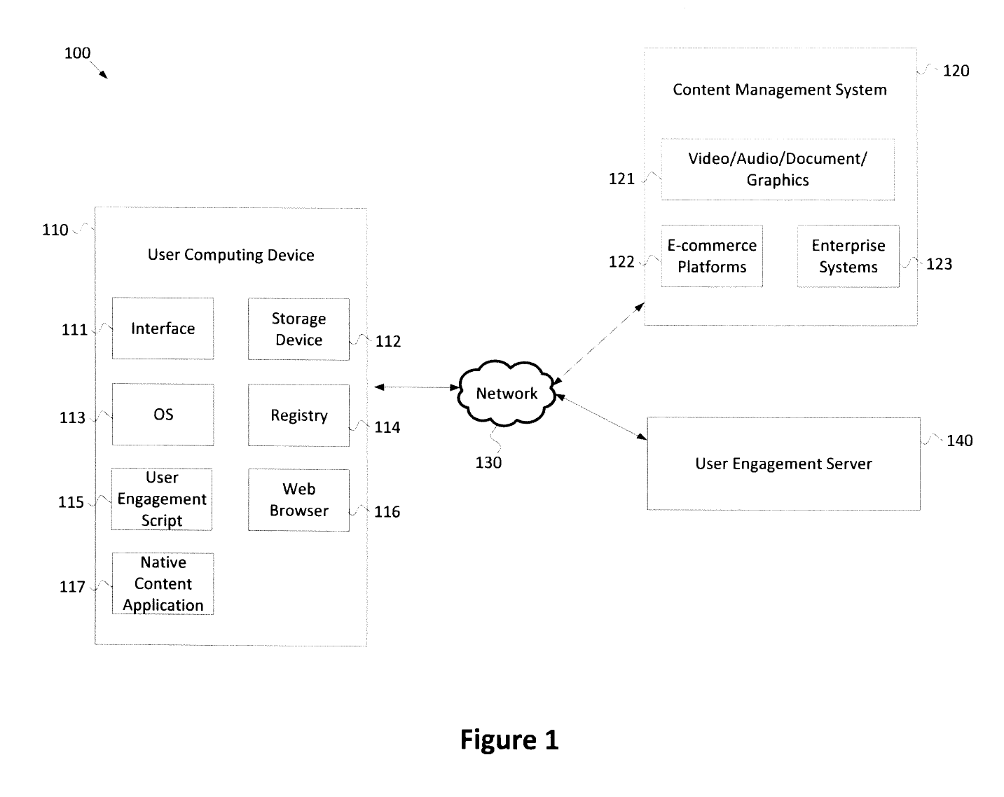

FIG. 1 is a system diagram showing a system 100 for user engagement according to some embodiments. As shown, the system 100 includes a user computing device 110, a content management system 120, a network 130, and a user engagement server 140.

User computing device 110 includes an interface 111, a storage device 112, an operating system 113, a registry 114, a user engagement script 115, a web browser 116, and a native content application 117. The user computing device 110 may be any of a variety of computing devices used by an end user, such as a laptop computer, a desktop computer, a smartphone, a tablet computer, etc. The interface 111 is an interface that the user can use to interact with the user computing device 110. The interface 111 may be any of a variety of combination of software and hardware, such as a touchscreen interface on a tablet computer or smartphone, a combination of a keypad and a non-touchscreen display screen on a cellular telephone, a combination of a keyboard with a non-touchscreen display of a laptop computer, etc. The storage device 112 is any of a variety of storage devices that may be used by the user computing device 110 to store data, including volatile and non-volatile storage devices such as RAM, flash memory, hard disks, etc. The operating system 113 is a software program that runs on user computing device 110 and provides basic functionality for the operation of the user computing device 110. The operating system 113 may be any of a variety of operating system programs, such as Mac OS, Windows, Linux, Android, etc.

The registry 114 is a file or some equivalent stored on the user computing device 110 that contains basic information about a user registered on the user computing device 110. The registry 114 may be a file, multiple files, or part of a file created by the operating system 113. The registry 114 may be created by the operating system 113 when the user initially registers on the user computing device 110 after purchase of the user computing device 110. The information contained in the registry 114 may be basic identifying information, such as a name or names of the registered user and an email address of the registered user. In various embodiments, other information managed by the operating system 113 may be included in the registry 114.

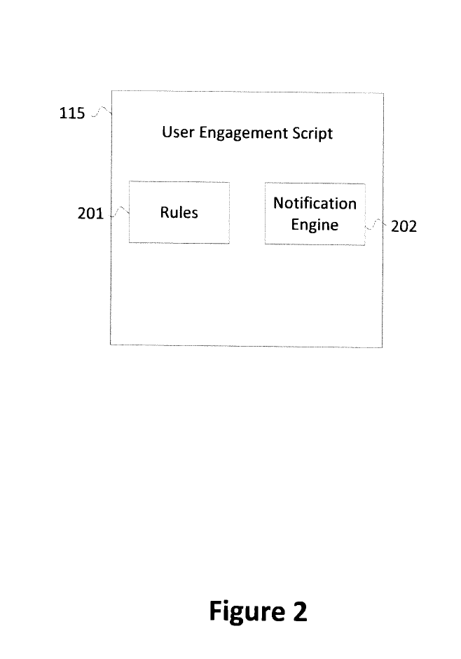

The user engagement script 115 is a program or some equivalent stored on the user computing device 110 that is capable of performing various user engagement tasks. The user engagement script 115 may be a small executable file that is capable of being executed on the user computing device 110. The user engagement script 115 may be capable of communicating with the content management system 120 over network 130. The user engagement script 115 may be capable of communicating with the user engagement server 140 over network 130. The user engagement script 115 may be capable of reading information stored in the registry 114 to perform user engagement tasks. The user engagement script 115 may be able to retrieve other information stored on the user computing device 110, such as an IP address or a MAC address, in order to perform user engagement tasks. The user engagement script 115 may contain rules 201 and a notification engine 202 as shown in greater detail in FIG. 2.

The user engagement script 115 may contain rules 201 used for performing user engagement tasks. For instance, user engagement script 115 may contain rules 201 regarding which user computing device (e.g., element 110) to deliver content notifications or content to; which hardware interface (e.g., element 111) to deliver content notifications or content to; which software interface (e.g., elements 113, 116, or 117) to deliver content notifications or content to; which mode to use for content notifications or content (e.g., an OS popup notification, an email, loading a webpage); what frequency of delivery of content notifications or content. In various embodiments, the user engagement script 115 may use other types of rule for user engagement tasks.

The user engagement script 115 may contain a notification engine 202 for performing user engagement tasks. The notification engine 202 may control when and how user engagement script 115 delivers content notifications to a user registered on the user computing device 110. For example, the notification engine 202 may use a schedule for content delivery to determine when to deliver content notifications to the user registered on the user computing device 110. As another example, the notification engine 202 may listen for instructions from user engagement server 140 as to content notifications that should be delivered to the user registered on the user computing device 110. In various embodiments, the user engagement script 115 may use the notification engine 202 in other ways for user engagement tasks.

User engagement script 115 may be installed on user computing device 110 by any suitable methods and in any suitable manners. In some embodiments, user engagement script 115 may be installed on the user computing device 110 prior to the sale of the user computing device 110 as a “new” product to the user. In this way, no additional installation steps are needed to include the user engagement script 115 in the user computing device 110. In some embodiments, user engagement script 115 may be installed on the user computing device 110 after sale of the user computing device 110 as a “new” product to the user, such as by downloading it over network 130. In this way, user computing device 110 may be configured to include user engagement script 115 even if it did not contain user engagement script at the time of sale to the user. In some embodiments, user engagement script 115 may be installed on the user computing device 110 after sale of the user computing device 110 as a “new” product to the user, such as by including user engagement script 115 in a software patch for operating system 113. In this way, user computing device 110 may be configured to include user engagement script 115 even if it did not contain user engagement script at the time of sale to the user, while the user engagement script 115 can be installed as part of an already planned software installation. The term “sale” here may refer to any transaction and transfer of goods, and need not necessarily involve monetary transactions.

Web browser 116 may be any web browser software operating on the user computing device 110. Web browser 116 may be capable of presenting a webpage to the user via interface 111 based on a uniform resource identifier (URI) or uniform resource locator (URL). Web browser 116 may be Safari, Internet Explorer, Firefox, etc., or some other web browser software.

Native content application 117 is a software application that runs natively on operating system 113 on user computing device 110. Native content application 117 may be capable of presenting content to the user via interface 111, such as video, audio, etc. Native content application 117 may have further content-related functionality. For example, native content application 117 may provide recommendations of content for the user to view, management of a profile for the user for a user engagement platform, management of a schedule for content delivery to the user, etc. Native content application 117 may contain a dashboard where the user can view content notification and personalized content previously delivered to the user. While web browser 116 may also provide these features via various webpages, the distinction between web browser 116 and native content application 117 is that web browser 116 present webpages to the user which may contain various functionalities, whereas the native content application 117 is itself programmed to provide various functionalities regardless of any particular webpage.

Content management system 120 includes video/audio/document/graphics content 121, e-commerce platforms 122, and enterprise systems 123. Content management system 120 is a system that manages and delivers content. In some embodiments, content management system 120 may include a federation of multiple distinct content management systems or other content sources. Video/Audio/Document/Graphics content 121 is any collection or group of content that can be managed and delivered by the content management system 120. This may include video files, audio files, word processing documents, graphics files, image files, PDF files, webpages, markup language files, webpages containing other content sources, electronic books, etc. E-commerce platforms 122 may be any computer based system for conducting transactions over a network, such as network 130. E-commerce platforms 122 may include sales websites, payment websites, banking websites, etc. Enterprise system 123 may be any software or hardware system provided by an enterprise that is accessible over a network, such as network 130. In some embodiments, content management system 120 may include or be part of or other be referred to as a digital assets manager.

Network 130 is a network that allows communication between the user computing device 110 and the content management system 120. Network 130 may be any of a variety of networks, such as a data communications network, the Internet, a local area network, a cellular network, a combination of instances of these types of networks, etc.

User engagement server 140 comprises a computer that assists the user engagement script 115 in performing user engagement tasks. For example, user engagement server 140 may contain information about the content preferences of the user registered on the user computing device 110. As another example, user engagement server 140 may contain information on a schedule of content delivery for the user registered on the user computing device 110. As another example, the user engagement server 140 may contain information necessary to produce a schedule of content delivery for the user registered on the user computing device 110. As another example, the user engagement server 140 may be capable of sending instructions to the user engagement script 115 for the presentation of a content notification or content to the user registered on the user computing device 110. As another example, the user engagement server 140 may be capable of interacting with the content management system 120 to select and prepare content for delivery to the user computing device 110. For these and other user engagement tasks, the user engagement server may communicate with the content management system 120 or components thereof over network 130. For these and other user engagement tasks, the user engagement server may communicate with the user computing device 110 or components thereof over network 130. In some embodiments, user engagement server 140 may be provided as part of content management system 120, or vice versa.

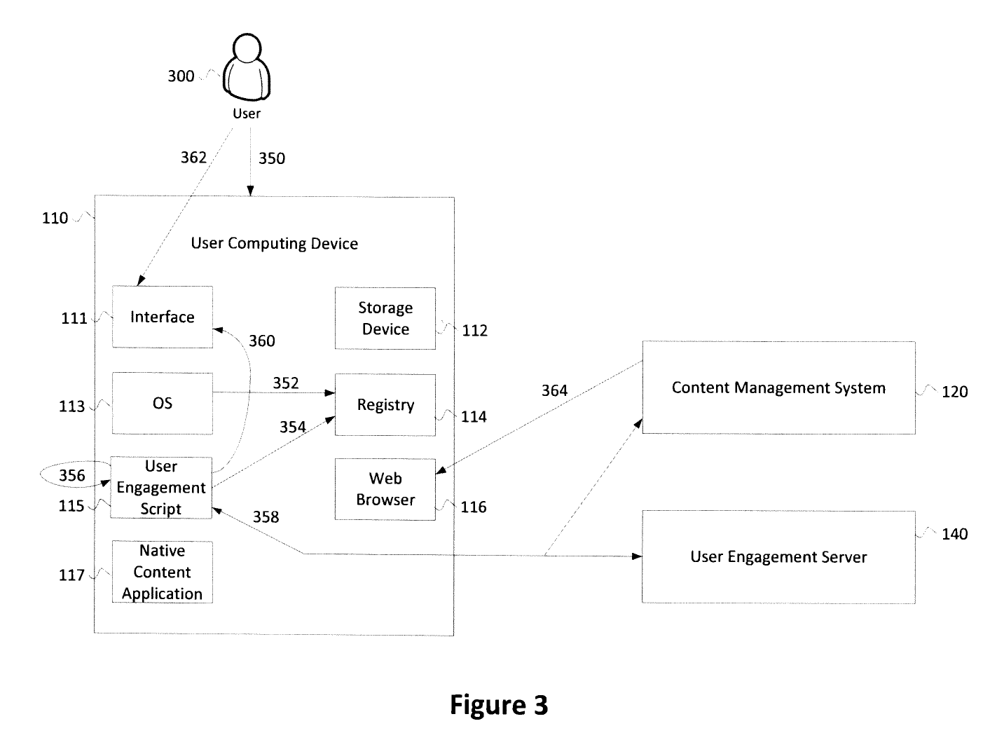

FIG. 3 is a schematic flowchart showing a user engagement technique according to some embodiments. FIG. 3 shows elements similar to those from previous figures. In addition, FIG. 3 shows a user 300.

At callout 350, the user 300 accesses the user computing device 110 for the first time after having purchased the user computing device 110. As part of this access, the user 300 provides personalized information as part of a registration process. The personalized information may include a name or names for the user, an email address for the user, and other information.

At callout 352, the operating system 113 creates a registry 114 containing the personalized information entered by the user 300 during registration. In the present exemplary embodiments, the registry 114 will be treated as a single data file created by the operating system 113 containing the personalized information entered by the user 300 during registration and stored on the user computing device 110.

At callout 354, the user engagement script 115 reads the contents of the registry 114 to retrieve the personalized information stored therein. In order to perform this reading, the user engagement script 115 may create a temporary copy of the file containing registry 114 in order to not prevent other applications from accessing the registry 114.

At callout 356, the user engagement script 115 generates scheduling information for content delivery. The scheduling information may include a schedule for content delivery to the user 300. The user engagement script 115 may generate the scheduling information based on various factors. The user engagement script 115 may generate the scheduling information based on the personalized information retrieved from registry 114. The user engagement script 115 may generate the scheduling information based on rules 201 included with user engagement script 201. The user engagement script 115 may generate the scheduling information based on a communication with user engagement serer 140 and scheduling parameters stored thereon. The user engagement script 115 may generate the scheduling information based on the user computing device 110, based on information stored on the user computing device 110, or based on a type or model of the user computing device 110.

At callout 358, the user engagement script 115 interfaces with the user engagement server 140 and/or the content management server 120 in order to prepare personalized content for the user 300. The user engagement script 115 may use the scheduling information created with respect to callout 356 in order to determine when to perform the actions descried with respect to this callout 358. The user engagement script 115 may interface with the user engagement server 140 and/or the content management server 120 in order to select content that should be delivered to the user 300. The user engagement script 115 may interface with the user engagement server 140 and/or the content management server 120 in order to personalize content that should be delivered to the user 300. The content may be personalized based on the personalized information retrieved from the registry 114, such as by adding the name of user 300 to the content. The content may be personalized based on information retrieved from user engagement server 140, such as by adding a photo of a pharmacist of the user 300 to the content based on information stored about the user 300 on user engagement server 140. The content may be personalized so as to provide coupons or other promotional offers that may be of interest to the user 300. The coupons or other promotional material may be selected based on personal interest graphs, personal dashboards, or other content based on preferences of the provider of the content. The content may be personalized based on the scheduling information generated with respect to callout 356. The content may be personalized based on a type or model of the user computing device 110 that the user 300 is using. The content may be personalized based on the location of the user 300. The content may be personalized using the rules 201. The rules 201 may define how content is personalized, what personalized information is used, what promotional offers to present to the user 300, and other parameters in personalizing the content. The content may be prepared as a video page having various points of personalized content presented on a single webpage or application screen for viewing by the user 300. Having prepared personalized content for the user 300, the user engagement script 115 may retrieve a URI, URL, or other reference to the personalized content.

At callout 360, the user engagement script 115 delivers a content notification to the user 300 via interface 111. The content notification may contain information informing the user 300 of the personalized content prepared with respect to callout 358 that is available for the user 300 to view, interact with, or otherwise retrieve. The content notification may be associated with the URI, URL, or other reference to the personalized content as retrieved with respect to callout 258. The content notification may be personalized in ways similar to those described for personalizing the content above. The user engagement script 115 may use rules 201 to determine to which user computing device (e.g., element 110), which hardware interface (e.g., element 111), and/or which software interface (e.g., elements 113, 116, and 117) to deliver the content notification.

The content notification may itself be presented in a variety of forms. The content notification may be a notification popup, which can be any popup message or window on the interface 111 displaying the content notification. The content notification may comprise, or be, a passive notification popup, which can be a notification popup that is displayed in on the interface 111 but does not change the focus of the interaction of the user 300 with the user computing device 110. For instance, a GROWL-style notification popup may be used that nonintrusively displays the notification popup. The content notification may be an active notification popup, which can be a notification popup that changes the focus of the interaction of the user 300 with the user computing device 110. The content notification may be an email message delivered to an email account of the user 300. The content notification may be a rich site summary (RSS) feed, a short message service (SMS) message, or a multimedia message service (MMS) message. The content notification may be accompanied by an audible signal to alert the user 300, such as a ding. The content notification may be a spoken message that reads the content notification and options for interaction to the user 300.

The style and type of the content notification may be configurable in various ways. The user 300 may be able to configure how the content notification is presented. A party involved in the preparation or ownership of the content that is personalized for the user 300 may be able to configure how the content notification is presented. The content notification may be automatically configured based on the context of the content notification, such as the particular device or type of device on which it is presented, the type of the content, and parameters specific to the user 300 to whom the content notification is presented.

At callout 362, the user 300 interacts with the content notification. This may involve the user 300 clicking, tapping on, or otherwise selecting the content notification via the interface 111. This may involve any other input from the user 300 that tends to indicate that the user 300 has an interest in the content of which the content notification is alerting the user 300.

At callout 364, the personalized content is delivered to the user computing device. As shown here, the content management system 120 delivers the personalize content to the web browser 116. In other embodiments, the personalized content may be delivered to native content application 117. The web browser 116 may cause the delivery of the personalized content by requesting a resource identified by the URI, URL, or other reference to the personalized content as retrieved with respect to callout 258. At this point the user 300 may view or otherwise interact with the personalized content using the user computing device 110. In some embodiments, the content may be delivered in real time or over a period of time. This determination may be made based on extraction rules contained in the user engagement script 115, the user engagement server 140, or the content management server 120.

In some embodiments, the content notification and personalized content may not be delivered to the same user computing device 110. For example, the content notification may be presented to the user 300 on a smartphone device, whereas an interaction by the user 300 with the content notification causes the personalized content to be delivered to a laptop computer. These situations may be particularly useful where a single user 300 is registered as a user on multiple user computing devices. The control of which user computing device is used for presentation of the content notification and which user computing device is used for delivery of the personal content may be determined in a variety of ways. Customization parameters set by the user 300 may be stored on the user engagement server 140 or on a user computing device 110 for controlling which user computing devices are selected for presentation of content notifications and delivery of personalized content. Rules associated with the provider to the user engagement server 140 and the user engagement script 115 may be used for controlling which user computing devices are selected for presentation of content notifications and delivery of personalized content. A selection made by the user 300 at the time of interaction with the content notification may be used for controlling which user computing device is selected for delivery of personalized content.

In some embodiments features described as being provided by the user engagement script 115 may instead be provided by the user engagement server 140, and vice versa. For instance, the rules 201 and notification engine 202 may be provided in the user engagement server 140 in some embodiments. In some embodiments, both the user engagement script 115 and user engagement server 140 may contain rules 201.

In some embodiments, the user engagement script 115 may use transactional triggers for determining when to deliver content notifications. These transactional triggers may be used in additional to or in place of the scheduling information generated with respect to callout 356. Transactional triggers may include observance of the user 300 visiting a particular webpage or buying a particular product using user computing device 110. Transactional triggers may include information received by the user engagement script 115 from the user engagement server 140. This information may include information about webpages visited by the user 300 or a product purchase by the user 300.

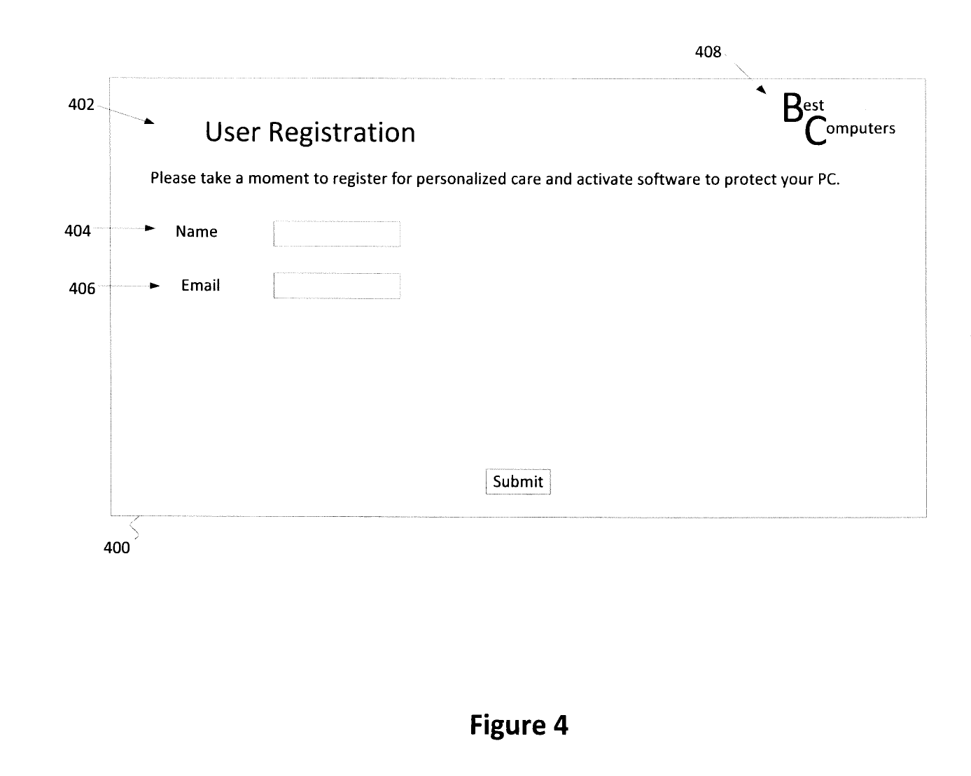

FIG. 4 is an exemplary registration interface according to some embodiments. As shown, the user may be presented with a screen 400. Screen 400 may be presented on an interface of a user computing device. Screen 400 may contain a greeting/instruction message 402, a name entry section 404, an email entry section 406, and a marketing section 408. The marketing section 408 may be used to present the user computing device manufacturer's logo. Using the screen 400, the user may be able to enter personalized information that the operating system can use to create a registry on the user computing device, as previously described.

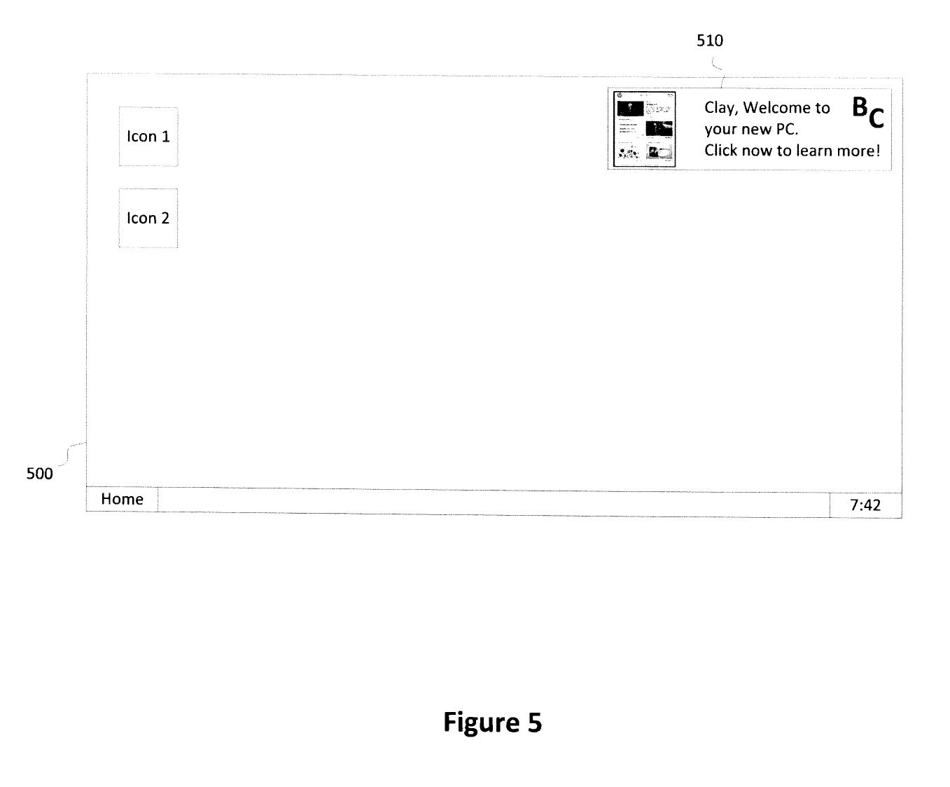

FIG. 5 is an exemplary user computing device interface with a content notification according to some embodiments. As shown, a standard home screen 500 may be provided. The user may generally interact with the home screen 500 for performing standard functions on the user computing device. A content notification 510 is shown as presented on the home screen 500. As shown, content notification may be a small popup message on the periphery of the screen 500 so as to not be intrusive to the user's existing interaction with screen 500. For example, content notification 510 may be presented as a passive notification popup in the fashion of a GROWL-style popup message. As shown, the content notification 510 can contain various information. Content notification 510 may contain a personalized message to the user, such as a message including the user's name and inviting the user to interact with the content notification 510. Content notification 510 may contain a marketing graphic, such as the “BC” marketing symbol for the manufacturer of the user computing device, Best Computers. Content notification 510 may contain a preview of personalized content that the user is invited to view. Though not presented in the content notification 510, a URI, URL, or other reference to the personalized content may be associated with the content notification. If the user interacts with the content notification, such as by clicking on it, the personalized content may be automatically loaded in a web browser or native content application running on the user computing device based on the associated URI, URL, or other reference to the personalized content.

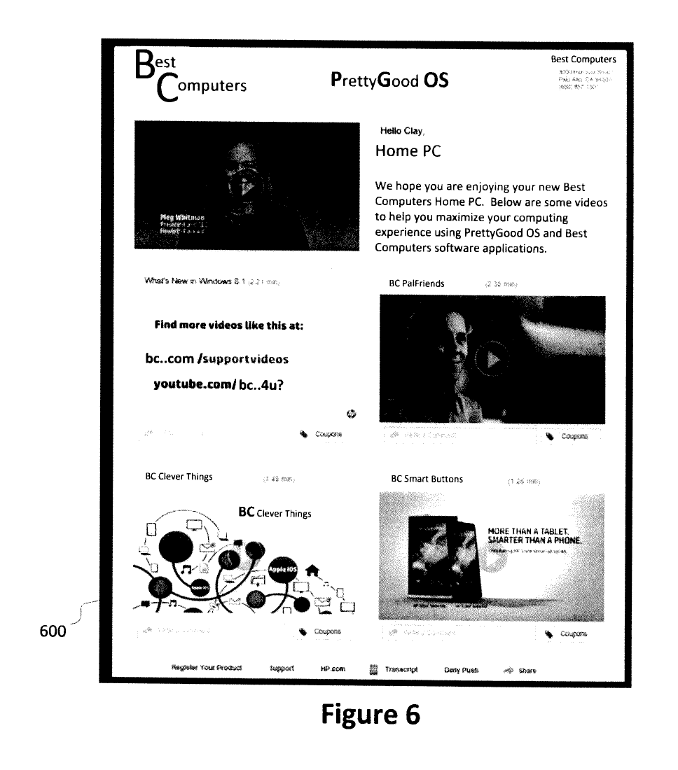

FIG. 6 shows an exemplary content interface 600 with personalized content according to some embodiments. As shown, the personalized content interface 600 may contain a variety of information. Personalized content interface 600 may contain marketing graphics or other information for the manufacturer of the user computing device (Best Computers), an operating system running on the user computing device (PrettyGood OS), or some other entity. Personalized content interface 600 may contain a personalized message to the user (Clay), inviting him to view or otherwise interact with the content presented on the personalized content interface 600. Personalized content interface 600 may contain various videos, links, or other content that may be of particular interest to the user. In some embodiments, the personalized content may be delivered in the form of a video page, such as that embodied in personalized content interface 600.

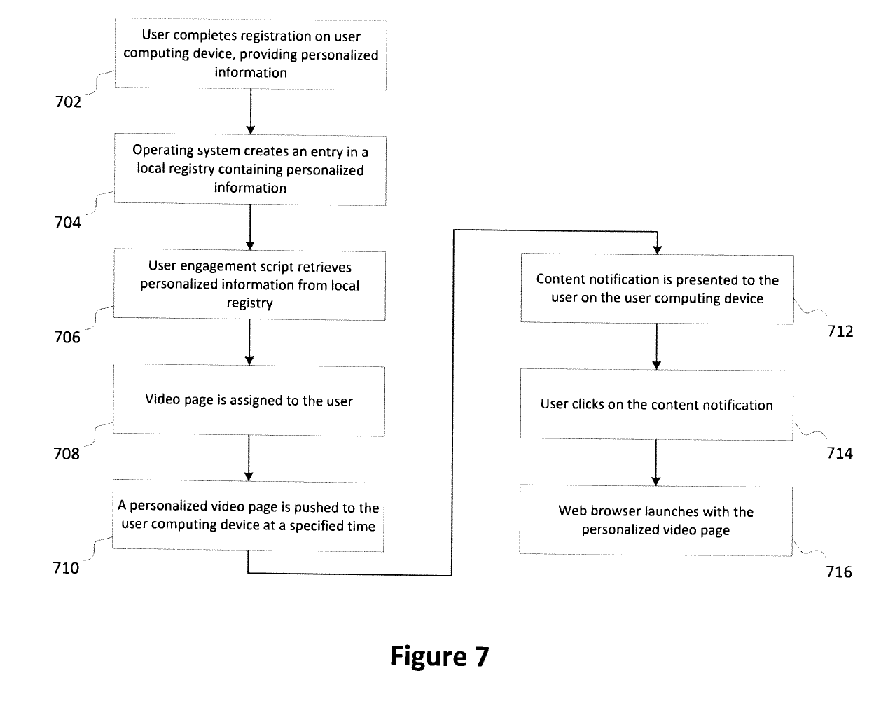

FIG. 7 is a flowchart showing a process of user engagement according to some embodiments. The process begins at step 702.

At step 702, the user completes registration on a user computing device. This registration may be part of an initial registration when first starting the user computing device after purchase. The user enters personalized information as part of the registration.

At step 704, the operating system receives the personalized information and creates an entry in a local registry containing the personalized information. Where a local registry does not exist, the operating system may newly create a local registry and then add a new entry.

At step 706, the user engagement script retrieves the personalized information for the user stored in the local registry.

At step 708, a video page is assigned to the user. The video page may be assigned to the user based on various factors. The personalized information retrieved from the local registry may be used to determine what video page to assign to the user. Information about the user stored on a user engagement server may be used to determine what video page to assign to the user. A content management system may be used during this step, where content for the video page may be managed by the content management system.

At step 710, a personalized video page is pushed to the user computing device at a specified time. In addition to video page, other type of information (e.g., sound, text, etc.) can be pushed. The assigned video page may be personalized based on various information, such as the personalized information retrieved from the local registry. The video page may be pushed in a variety of ways. For example, an instruction containing a reference to the video page may be sent to the user engagement script running on the user computing device in order to push the video page to the user computing device. The time for pushing the personalized video page may be specified in a variety of ways. For example, fixed period of time after the initial registration by the user takes place may be used to determine the specified time.

At step 712, a content notification is presented to the user on the user computing device. In some embodiments, this may involve presenting a passive notification popup, or GROWL-style message, or both, to the user on an interface of the user computing device.

At step 714, the user clicks on the content notification. In some embodiments, a different interaction of the user with the content notification may satisfy step 714, such as tapping on the content notification on a touchscreen display or hovering over the content notification with a cursor.

At step 716, a web browser launches with the personalized video page on the user computing device. In some embodiments, a native content application running on the user computing device may be used to present the personalized video page instead of the web browser.

The process then terminates.

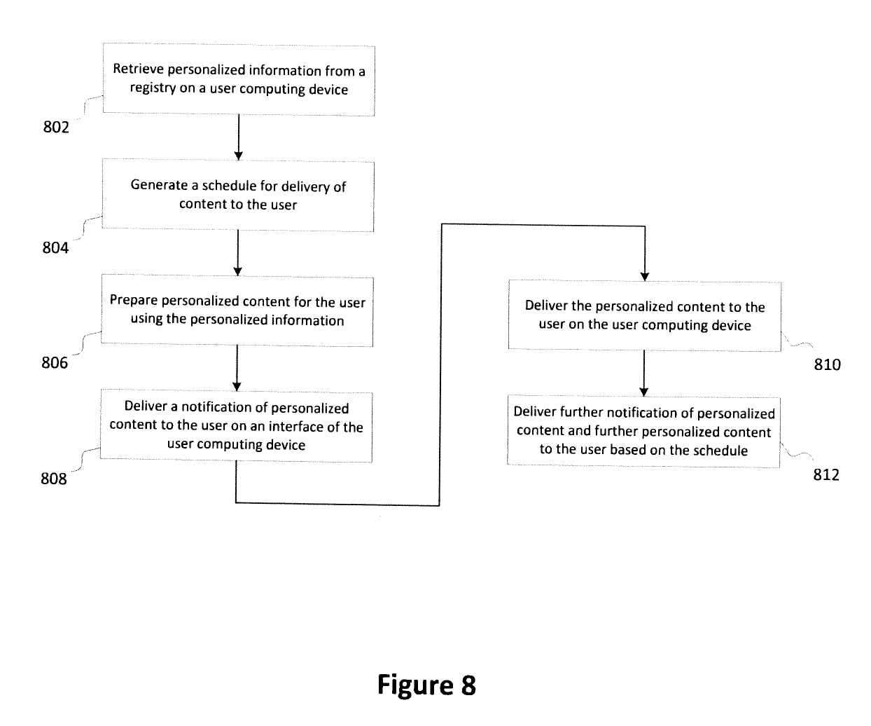

FIG. 8 is a flowchart showing a process of user engagement according to some embodiments. The process begins at step 802.

At step 802, personalized information is retrieved from a registry on a user computing device. The personalized information may be stored in the registry based on a previous registration process for the user on the user computing device.

At step 804, a schedule for delivery of content to the user is generated. The schedule may be generated on the user computing device or on a separate computing device, such as a user engagement server. The schedule may define times at which personalized content should be delivered to the user.

At step 806, personalized content is prepared for the user using the personalized information retrieved from the registry. This preparation of personalized content may involve adding a name of the user to the personalized content, selecting content that may be of particular interest to the user, determining a particular user computing device to which deliver the personalized content based on information about one or more registrations of the user on user computing devices, or some other form of personalization.

At step 808, a notification of personalized content is delivered to the user on an interface of the user computing device. In some embodiments, this may involve presenting a passive notification popup, or GROWL-style message, to the user on an interface of the user computing device.

At step 810, the personalized content is delivered to the user based on an interaction of the user with the notification of personalized content. This delivery of personalized content may include launching a web browser or a native content application.

At step 812, further notifications of personalized content and further personalized content are delivered to the user on the user computing device in accordance with the previously generated schedule.

The process then terminates.

Through the embodiments described in this disclosure, various enhancements to user engagement are provided.

In some of the embodiments described herein, improvements to the level of personalization of the user engagement are provided. In some embodiments, a highly personalized experience is provided to the user, including personalization of the content notification, personalization of the content itself, and personalization of how and where the content is delivered. These forms of personalization are possible at least because the user engagement script is provided running on the native operating system of the user computing devices. Based on this user engagement script, personalized information identifying the user can be retrieved, but also that user can be tied to particular user computing devices. In this way, the content notifications and personalized content need not only be delivered to a software platform (e.g., email, social media), but can also be targeted to particular hardware devices.

In some of the embodiments described herein, improvements to the automation of user engagement are provided. In some embodiments, the delivery of personalized content for user engagement is mostly automated, based on processes running on the user computing device, the content management system, the user engagement server, and elsewhere. The generation of a content delivery schedule is a particular example of this. These improvements to automation make personalized interaction with large groups of users feasible, given that manual intervention is not required on every personalized interaction.

In some of the embodiments described herein, improvements to the customization by users of their own user engagement are provided. In some embodiments, the user is able to customize various features of the user engagement, including how content notifications are delivered and what the schedule of personalized content delivery should be. These improvements allow each individual user to tweak his or her personal interaction with the user engagement platform and thereby have a more enjoyable and effective user engagement.

In some of the embodiments described herein, improvements to the depth of personalization of user engagement are provided. In some embodiments, the user engagement script on the user computing device along with the user engagement server, the content management system, and other data sources allow for a highly personalized interaction with the user due to the large amounts of information available about the user. Through these various components, information about purchases by the user, webpages visited by the user, videos liked by the user, and other information specific to each user can be used to create a highly in-depth personalization of the user engagement. These improvements allow the delivery of user engagement to the user that is more relevant to the user and thus more likely to be effective with engaging the user.

In some of the embodiments described herein, improvements provided allow for real-time personalized engagement, e-commerce, and customer support opportunities leading to additional sales, lower cost of support of new products (better operational support model), lower returns of new products, and much more.

### Additional Notes

As noted, an exemplary system for implementing the overall system or portions thereof provided herein might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

Embodiments provided herein include program products comprising machine-readable media with machine-executable instructions or data structures stored thereon. Such machine-readable media can be any available storage media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions. Note that the machine-executable instructions/programming code may comprise algorithms embedded in Excel or other spreadsheets.

Embodiments provided herein have been described in the general context of method steps which may be implemented in embodiments by a program product including machine-executable instructions, such as program code, for example in the form of program modules executed by machines in networked environments. Generally, program modules include routines, programs, objects, components, data structures, etc., that perform particular tasks or implement particular data types. Multi-threaded applications may be used, for example, based on Java or C++. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments provided herein may be practiced with one or multiple computers in a networked environment using logical connections to one or more remote computers (including mobile devices) having processors. Logical connections may include a local area network (LAN) and a wide area network (WAN) that are presented here by way of example and not limitation. Such networked environments are commonplace in office-wide or enterprise-wide computer networks, and include intranets and the Internet, and may use a wide variety of different communication protocols. Those skilled in the art will appreciate that such network computing environments will typically encompass many types of computer system configurations, including personal computers, hand-held devices such as mobile phones and other PDA appliances, multi-processor systems, microprocessor-based or programmable consumer electronics, network PCs, minicomputers, mainframe computers, and the like. Embodiments provided herein may also be practiced in distributed computing environments where tasks are performed by local and remote processing devices that are linked (either by hardwired links, wireless links, or by a combination of hardwired and wireless links) through a communications network. In a distributed computing environment, program modules may be located in both local and remote memory storage devices.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the embodiments provided herein. Likewise, software and web implementations of the embodiments provided herein could be accomplished with programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations. It should also be noted that the phrase “a plurality” is intended to mean more than one, and is not intended to refer to any previous recitation of the word “plurality,” unless preceded by the word “the.”

All components, modes of communication, and/or processes described heretofore are interchangeable with similar components, modes of communication, and/or processes disclosed elsewhere in the specification, unless an express indication is made to the contrary.

While the embodiments provided herein has been described in conjunction with the exemplary embodiments outlined above, it is evident that many alternatives, modifications and variations will be apparent to those skilled in the art. Accordingly, the exemplary embodiments provided herein, as set forth above, are intended to be illustrative, not limiting. Various changes may be made without departing from the spirit and scope of the embodiments provided herein.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments provided herein can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the embodiments provided herein may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed:

1. A method comprising:
retrieving user information of a user from a local registry on a user computing device;
delivering a notification of personalized content to the user using an interface of the user computing device, wherein the notification is generated based at least on the user information retrieved from the local registry; and
delivering the personalized content to the user based on an interaction of the user with the notification.

2. The method of claim 1,
wherein the notification comprises a passive notification popup.

3. The method of claim 1,
wherein the notification comprises a GROWL style notification.

4. The method of claim 1,
wherein the notification comprises a passive notification popup, and
wherein the interaction of the user with the notification comprises the user interacting with the passive notification popup.

5. The method of claim 1,
wherein the notification comprises a passive notification popup,
wherein the interaction of the user with the notification comprises the user interacting with the passive notification popup, and
wherein the delivering the content to the user further comprises loading a webpage identified by a uniform resource identifier associated with the passive notification popup.

6. The method of claim 1,
wherein the notification comprises a passive notification popup,
wherein the interaction of the user with the notification comprises the user interacting with the passive notification popup, and
wherein the delivering the personalized content to the user further comprises launching a native content application installed on the user computing device.

7. The method of claim 1,
wherein the notification comprises a passive notification popup,
wherein the interaction of the user with the notification comprises the user interacting with the passive notification popup, and
wherein the passive notification popup is personalized for the user based at least on the user information retrieved from the local registry.

8. The method of claim 1, further comprising:
interfacing with a content management system,
wherein the content management system is installed on a remote computing device, and
wherein the interfacing with a content management system further comprises communication between a user engagement software module installed on the user computing device and the content management system over a data communications network.

9. The method of claim 1, further comprising:
interfacing with a content management system,
wherein the content management system is installed on a remote computing device,
wherein the interfacing with a content management system further comprises communication between a user engagement software module installed on the user computing device and the content management system over a data communications network, and
wherein the content is determined at least by the content management system.

10. The method of claim 1, further comprising:
generating a schedule for content delivery based at least on the user information retrieved from the local registry.

11. The method of claim 1, further comprising:
generating a schedule for content delivery based at least on the user information retrieved from the local registry,
wherein the delivering a notification of personalized content to the user is performed based on the schedule for content delivery.

12. The method of claim 1,
wherein the user information of the user is stored in the local registry as a part of a registration process for the user and the user computing device.

13. The method of claim 1,
wherein the delivering the personalized content to the user is based at least on rules for content delivery.

14. The method of claim 1,
wherein the delivering the personalized content to the user is based at least on rules for content delivery,
wherein the rules for content delivery are stored by a user engagement software module installed on the user computing device, and
wherein the rules for content delivery include at least one of: rules specifying an interface for delivery of content notifications, rules specifying a mode for delivery of content notifications, and rules specifying a frequency of delivery of content notifications.

15. The method of claim 1, further comprising:
installing a user engagement software module on the user computing device,
wherein the user engagement software module is configured to perform the retrieving the user information of the user from the local registry.

16. A system comprising:
a user computing device comprising:
a user interface configured to interact with a user;
a storage device configured to store thereon a local registry; and
a user engagement software module configured to retrieve user information of a user from the local registry;
a content server configured to store a personalized content; and
wherein
the user engagement software module is configured to deliver a notification of the personalized content to the user on the user interface,
the user engagement software module is configured to generate the notification based at least on the user information retrieved from the local registry, and
the content server is configured to deliver the personalized content to the user computing device based at least on an interaction of the user with the notification.

17. The system of claim 16,
wherein the user engagement software module is further configured to generate a schedule for content delivery based at least on the user information retrieved from the local registry.

18. The system of claim 16,
wherein the user engagement software module is installed on the user computing device prior to a sale of the user computing device to the user, and
wherein the sale of the user computing device to the user is a first retail sale of the user computing device.

19. The system of claim 16,
wherein the user engagement software module is installed on the user computing device as part of an installation of an update to an operating system executing on the user computing device.

20. A non-transitory machine-readable medium stored thereon a program, which, when executed, causes a user computing device to perform a method comprising:
retrieving user information of a user from a local registry on a user computing device;
delivering a notification of personalized content to the user using an interface of the user computing device, wherein the notification is generated based at least on the user information retrieved from the local registry; and
delivering the personalized content to the user based on an interaction of the user with the notification.
